(19) United States
(12) Patent Application Publication
(10) Pub. No.: US 2026/0147441 A1
(43) Pub. Date: May 28, 2026

(54) INFORMATION PROCESSING APPARATUS, INFORMATION PROCESSING METHOD, NON-TRANSITORY RECORDING MEDIUM, AND INFORMATION PROCESSING SYSTEM

(71) Applicant: Masahiro UEDA, Tokyo (JP)

(72) Inventor: Masahiro UEDA, Tokyo (JP)

(21) Appl. No.: 19/351,332

(22) Filed: Oct. 7, 2025

(30) Foreign Application Priority Data
Nov. 22, 2024 (JP) 2024-204022

(51) Int. Cl. G06F 3/04815; G06T 19/20

(52) U.S. Cl. CPC G06F 3/04815; G06T 19/20; G06T 2219/2004; G06T 2219/2012

(57) ABSTRACT

An information processing apparatus includes circuitry. The circuitry creates a screen that displays first data and second data as superimposed on each other. The first data is one of a plurality of three-dimensional data items obtained through measuring a target object at a plurality of different times. The second data is another one of the plurality of three-dimensional data items different from the first data. The screen includes, in an area including the second data alone, a first area and a second area different from the first area. In the first area, a distance between the first data and the second data is less than a threshold value. The first area displays the second data in a first display style. The second area displays the second data in a second display style different from the first display style.

### CROSS-REFERENCE TO RELATED APPLICATIONS

This patent application is based on and claims priority pursuant to 35 U.S.C. § 119(a) to Japanese Patent Application No. 2024-204022, filed on Nov. 22, 2024, in the Japan Patent Office, the entire disclosure of which is hereby incorporated by reference herein.

### BACKGROUND

### Technical Field

The present disclosure relates to an information processing apparatus, an information processing method, a non-transitory recording medium, and an information processing system.

### Related Art

There is a technique of aligning a plurality of three-dimensional data items obtained through the measurement of a target object and displaying the three-dimensional data items as superimposed on each other.

For example, there is an image processing system that displays superimposed images such that, in respective areas of interest of a plurality of superimposed three-dimensional data items, a part of an outer area of interest is hidden to display an inner area of interest.

### SUMMARY

The present disclosure described herein provides an information processing apparatus that includes, for example, circuitry that creates a screen that displays first data and second data as superimposed on each other. The first data is one of a plurality of three-dimensional data items obtained through measuring a target object at a plurality of different times. The second data is another one of the plurality of three-dimensional data items different from the first data. The screen includes, in an area including the second data alone, a first area and a second area different from the first area. In the first area, a distance between the first data and the second data is less than a threshold value. The first area displays the second data in a first display style. The second area displays the second data in a second display style different from the first display style.

The present disclosure described herein further provides an information processing method that includes, for example, creating a screen that displays first data and second data as superimposed on each other. The first data is one of a plurality of three-dimensional data items obtained through measuring a target object at a plurality of different times. The second data is another one of the plurality of three-dimensional data items different from the first data. The information processing method further includes displaying the screen on a display. The screen includes, in an area including the second data alone, a first area and a second area different from the first area. In the first area, a distance between the first data and the second data is less than a threshold value. The first area displays the second data in a first display style. The second area displays the second data in a second display style different from the first display style.

The present disclosure described herein further provides a non-transitory recording medium storing a plurality of instructions which, when executed by one or more processors, causes the one or more processors to perform the above-described information processing method.

The present disclosure described herein further provides an information processing system that includes, for example, circuitry. The circuitry creates a screen that displays first data and second data as superimposed on each other. The first data is one of a plurality of three-dimensional data items obtained through measuring a target object at a plurality of different times. The second data is another one of the plurality of three-dimensional data items different from the first data. The circuitry displays the screen on a display. The screen includes, in an area including the second data alone, a first area and a second area different from the first area. In the first area, a distance between the first data and the second data is less than a threshold value. The first area displays the second data in a first display style. The second area displays the second data in a second display style different from the first display style.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating general arrangement of an example of an information processing system according to a first embodiment of the present disclosure;

FIG. 2 is a diagram illustrating a hardware configuration of an example of a terminal apparatus and a management server in the information processing system according to the first embodiment;

FIG. 3 is a functional block diagram illustrating an example of the information processing system according to the first embodiment;

FIG. 4 is a diagram illustrating an example of a display screen of a three-dimensional (3D) viewer according to the first embodiment;

FIG. 5 is a functional block diagram illustrating an example of a 3D superimposition processing unit of the management server according to the first embodiment;

FIG. 6 is a diagram illustrating an example of 3D data obtained by photographing an entire room;

FIG. 7 is a diagram illustrating an example of 3D data obtained by rephotographing a part of the room;

FIG. 8 is a diagram illustrating an example of a superimposed screen created with a related-art technique;

FIGS. 9A and 9B are diagrams illustrating examples of a screen displaying two 3D data items superimposed on each other according to the first embodiment;

FIG. 10 is a diagram illustrating an example of degrees of transparency of component elements of second data determined by a screen creation unit of the management server according to the first embodiment;

FIG. 11 is a sequence diagram illustrating an example of 3D data processing according to the first embodiment;

FIG. 12 is a diagram illustrating an example of a setting screen according to the first embodiment;

FIG. 13 is a flowchart illustrating an example of a procedure of a 3D superimposition process according to the first embodiment;

FIG. 14 is a diagram illustrating an example of color component values of the component elements of the second data determined by the screen creation unit according to a second embodiment of the present disclosure; and

FIG. 15 is a diagram illustrating an example of a selection screen according to a third embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

In industries such as civil engineering and architecture, building information modeling (BIM)/construction information modeling (CIM) has been adopted to address issues such as aging population with declining birthrate and improvement in labor productivity.

BIM is a solution to utilize, in all phases of the architectural process from design to construction to maintenance and management, the information of a database of a building created by adding attribute data such as cost, finishing, and management information to a three-dimensional digital model of the building created on a computer (hereinafter referred to as the 3D model).

CIM is a solution for the civil engineering sector (overall infrastructure such as roads, power, gas, and water supply) proposed to emulate BIM already introduced and developed in the architectural field. Similarly to BIM, CIM is built around a 3D model to enable involved parties to share information to streamline and refine a series of processes in a construction and production system.

A point to consider in promoting BIM/CIM is how three-dimensional data (3D data) of a target object such as the space of a building or public facility is readily obtained. Herein, the 3D data refers to a three-dimensional point cloud (hereinafter occasionally simply referred to as the point cloud) retaining range information to the target object obtained by measuring the target object with a laser scanner (hereinafter referred to as the LS), a mesh object generated based on point cloud data representing the three-dimensional point cloud, or a 3D-computer aided design (CAD) model, for example.

In constructing a structure from zero, the use of BIM/CIM software, for example, enables designing the final product from nothing. In this case, BIM/CIM is readily introduced. In the case of an existing building, on the other hand, it is more difficult to apply BIM/CIM for a reason such as the original design blueprint no longer exists or the building has been renovated over time to be different from the original design plan. Applying BIM to such an existing building is called as-build BIM, which is a major issue in promoting BIM/CIM forward in the future.

As a measure for implementing as-build BIM, there is a workflow including measuring a space with the above-described LS and creating a 3D-CAD model based on point cloud data obtained through the measurement. Methods traditionally used in this task include measuring with photographs or a tape measure and sketching by hand. However, such methods may cause a substantial increase in work cost, depending on factors such as the size of the space, the presence or absence of equipment or furnishings in the space, and the complexity of the space (e.g., how complicated the piping or plumbing is). Therefore, introducing the LS to obtain the 3D data of the space has attracted attention as a useful method to address this issue.

With as-build BIM using the LS, the 3D data is readily obtained, but there arises a new task of information processing on the 3D data (3D data processing), which is absent in the traditional work. Typical 3D data processing includes the measurement at multiple points with the LS, the generation of an integrated point cloud by aligning multiple point clouds, the removal of unnecessary point clouds such as noise point clouds, the conversion of the point cloud into a mesh, the application of texture mapping to the mesh, the conversion into a 3D-CAD model, an alignment process, and the superimposition of multiple 3D data items, for example.

A first embodiment of the present disclosure will be described.

In the first embodiment, when a plurality of 3D data items obtained by measuring a target object at different times are displayed as superimposed on each other, the display style of each of elements (component elements) of the 3D data items is changed in accordance with relative positions of the 3D data items to improve the visibility of the 3D data items. As an example of the display style, the respective degrees of transparency of the component elements of 3D data obtained in the past may be increased to improve the visibility of newly obtained 3D data.

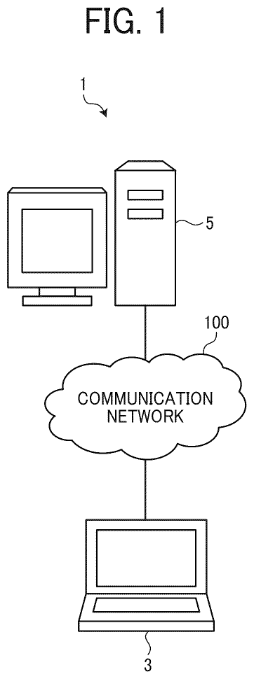

FIG. 1 is a diagram illustrating general arrangement of an example of an information processing system 1 according to the first embodiment. The information processing system 1 of the first embodiment includes a management server 5 and a terminal apparatus 3, which is an example of a communication terminal.

The management server 5 is an example of an information processing apparatus that executes a single or multiple types of information processing on 3D data such as a three-dimensional point cloud or a mesh object.

Herein, the three-dimensional point cloud is a set of coordinate points in the XYZ directions, for example, corresponding to measurement points on the surface of an object when a certain space of the object is measured with the LS, for instance. Each of the coordinate points is represented as (1, 3, 5), for example. The coordinate point may be added with color information. The values of red (R), green (G), and blue (B) as color components of the coordinate point may be added as the color information.

The three-dimensional point cloud may also be called the point cloud. Point cloud data is data of the three-dimensional point cloud that may be handled on a computer, for example, as a set of coordinate points in a virtual three-dimensional space.

In the above-described example, the three-dimensional point cloud is measured with the LS. The three-dimensional point cloud may also be measured with another type of optical or mechanical measurement means. The another type of optical measurement means may be a method using a stereo camera or visual simultaneous localization and mapping (SLAM), for example.

The terminal apparatus 3 and the management server 5 communicate with each other via a communication network 100. The communication network 100 is implemented by the Internet, a mobile communication network, or a local area network (LAN), for example. The communication network 100 may include, as well as a wired communication network, a wireless communication network using third generation (3G), worldwide interoperability for microwave access (WiMAX®), long term evolution (LTE long term evolution), or fifth generation (5G), for example. The terminal apparatus 3 is communicable with a short-range communication technology such as near field communication (NFC®).

A hardware configuration of the first embodiment will be described.

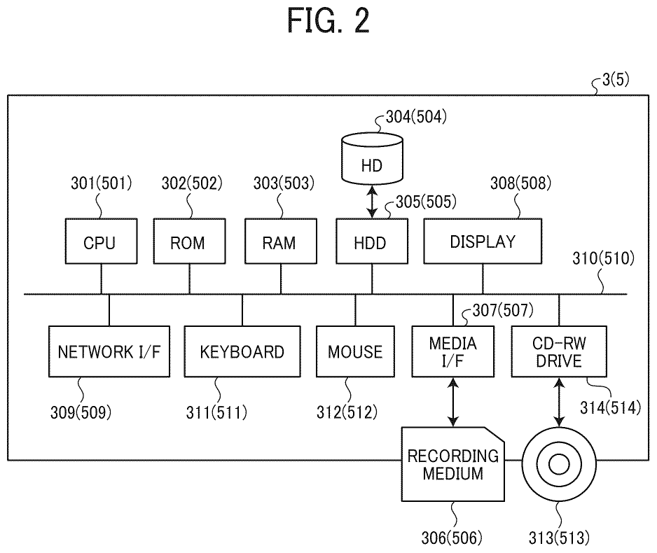

FIG. 2 is a diagram illustrating a hardware configuration of an example of the terminal apparatus 3 and the management server 5 according to the first embodiment. Hardware components of the terminal apparatus 3 are denoted with reference numbers 301 to 314. Hardware components of the management server 5 are denoted with reference numbers 501 to 514.

The terminal apparatus 3 includes a central processing unit (CPU) 301, a read only memory (ROM) 302, a random access memory (RAM) 303, a hard disk (HD) 304, a hard disk drive (HDD) 305, a recording medium 306, a media interface (I/F) 307, a display 308, a network I/F 309, a keyboard 311, a mouse 312, a compact disc-rewritable (CD-RW) drive 314, and a bus line 310.

The CPU 301 controls overall operation of the terminal apparatus 3. The ROM 302 stores programs used to drive the CPU 301. The RAM 303 is used as a work area of the CPU 301. The HD304 stores various data such as programs. The HDD 305 controls the writing or reading of various data to or from the HD 304 under the control of the CPU 301. The media I/F 307 controls the writing (storage) or reading of data to or from the recording medium 306 such as a flash memory.

The display 308 displays various information such as a cursor, menus, windows, text and images The network I/F 309 is an interface for performing data communication via the communication network 100. The keyboard 311 is a type of input means including multiple keys for inputting text, numerical values, and various instructions, for example. The mouse 312 is a type of input means for selecting and executing various instructions, selecting a processing target, and moving the cursor, for example. The CD-RW drive 314 controls the writing or reading of various data to or from a CD-RW 313 as an example of a removable recording medium. The terminal apparatus 3 may further include a component that controls the writing (storage) or reading of data to or from an external personal computer (PC) or an external device connected to the terminal apparatus 3 by wired communication or wireless communication using wireless fidelity (Wi-Fi®).

The management server 5 includes a CPU 501, a ROM 502, a RAM 503, an HD 504, an HDD 505, a recording medium 506, a media I/F 507, a display 508, a network I/F 509, a keyboard 511, a mouse 512, a CD-RW drive 514, and a bus line 510. These components are similar in configuration to the above-described components (the CPU 301, the ROM 302, the RAM 303, the HD 304, the HDD 305, the recording medium 306, the media I/F 307, the display 308, the network I/F 309, the keyboard 311, the mouse 312, the CD-RW drive 314, and the bus line 310), and thus the description thereof will be omitted.

The CD-RW drive 314 or 514 may be replaced by a compact disc-recordable (CD-R) drive, for example. Each of the terminal apparatus 3 and the management server 5 may be implemented by a single computer or by a plurality of computers to which units (functions, means, and memories) of the terminal apparatus 3 or the management server 5 are divided and allocated as desired.

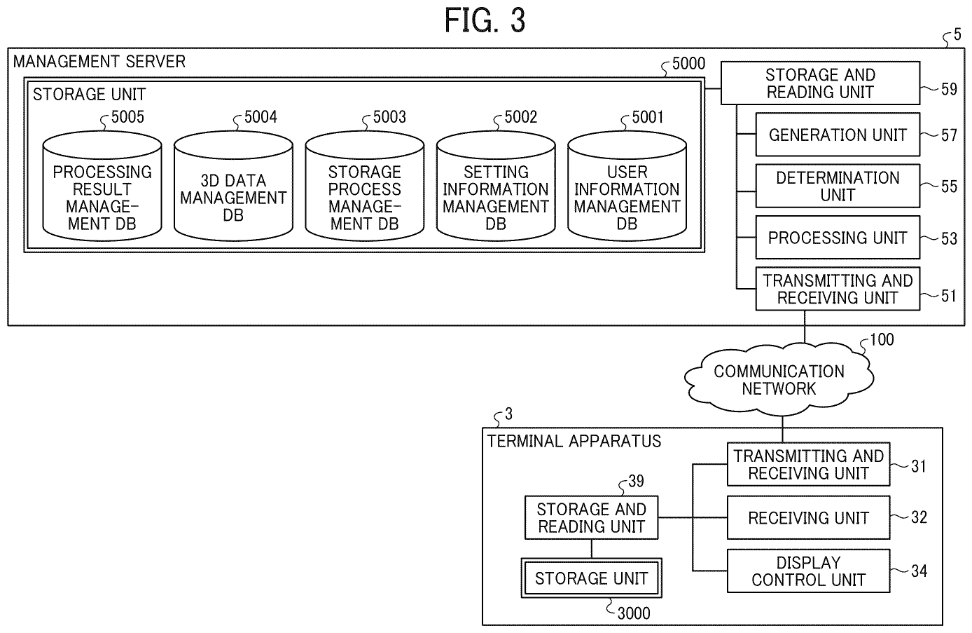

FIG. 3 is a functional block diagram illustrating an example of the information processing system 1 according to the first embodiment.

A functional configuration of the terminal apparatus 3 will be described.

As illustrated in FIG. 3, the terminal apparatus 3 includes a transmitting and receiving unit 31, a receiving unit 32, a display control unit 34, and a storage and reading unit 39. Each of these units is a function or functional means implemented by at least one of the components in FIG. 2 operating based on a command from the CPU 301 in accordance with a program deployed in the RAM 303 from the HD 304. The terminal apparatus 3 further includes a storage unit 3000 implemented by the RAM 303 and the HD 304 in FIG. 2.

The respective functional components of the terminal apparatus 3 will be described.

The transmitting and receiving unit 31 is an example of receiving means. The transmitting and receiving unit 31 is implemented by a command from the CPU 301 in FIG. 2 and the network I/F 309 to transmit and receive various data (or information) to and from another terminal, apparatus, or system via the communication network 100.

The receiving unit 32 is an example of reception means. The receiving unit 32 is mainly implemented by a command from the CPU 301 in FIG. 2, the keyboard 311, and the mouse 312 to receive various inputs from a user.

The display control unit 34 is an example of display control means. The display control unit 34 is implemented by a command from the CPU 301 in FIG. 2 to cause the display 308, which is an example of a display unit, to display various images and screens.

The terminal apparatus 3 displays 3D data with an application that visualizes 3D data (a 3D viewer). The 3D viewer is a world wide web (Web) application used through a Web browser, a PC application that runs on a PC, or a smartphone application that runs on a smartphone, for example.

The 3D data is uploaded on a cloud service or stored in a device of the terminal apparatus 3, which is a PC or smartphone. The terminal apparatus 3 visualizes the 3D data on the 3D viewer regardless of the type of the 3D viewer or the location of the 3D data. The 3D data may be data in any format dividable into component elements, such as a mesh or a point cloud.

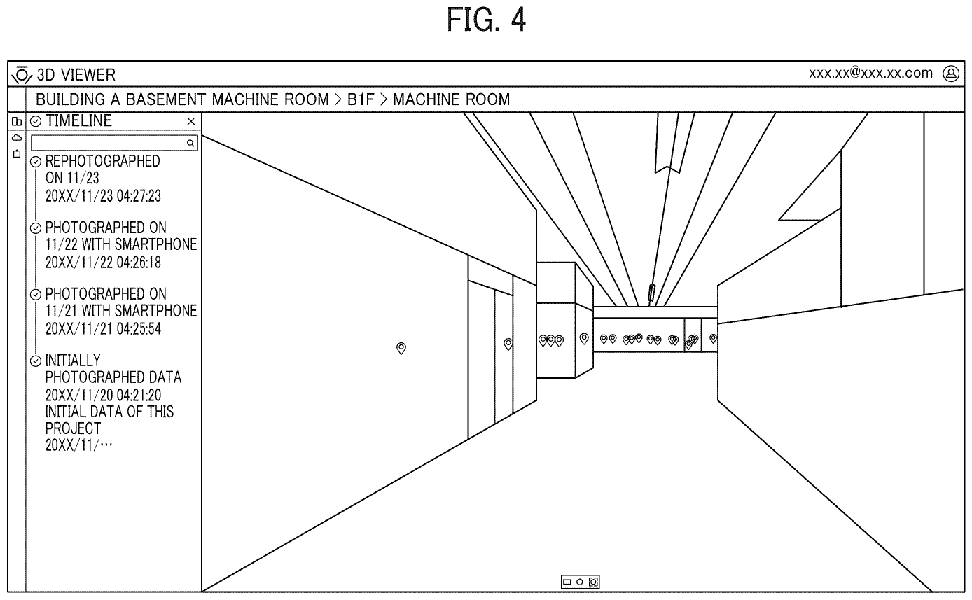

FIG. 4 is a diagram illustrating an example of a display screen of the 3D viewer. In this example, the 3D viewer displays an initially photographed 3D data item out of a plurality of 3D data items of a machine room obtained (photographed) on different dates and times. The 3D viewer enables the user to display the 3D data by changing the perspective as desired in six patterns in total; parallel translations in the respective directions in three-dimensional space, the rotation in the roll direction, the rotation in the pitch direction, and the rotation in the yaw direction.

The storage and reading unit 39 is an example of storage control means. The storage and reading unit 39 is implemented by a command from the CPU 301 in FIG. 2, the HDD 305, the media I/F 307, the CD-RW drive 314, the external PC, and the external device. The storage and reading unit 39 performs processes such as storing various data in the storage unit 3000, the recording medium 306, the CD-RW 313, the external PC, or the external device and reading various data therefrom.

A functional configuration of the management server 5 will be described.

The management server 5 includes a transmitting and receiving unit 51, a processing unit 53, a determination unit 55, a generation unit 57, and a storage and reading unit 59. Each of these units is a function or functional means implemented by at least one of the components in FIG. 2 operating based on a command from the CPU 501 in accordance with a program deployed in the RAM 503 from the HD 504. The management server 5 further includes a storage unit 5000 implemented by the HD 504 in FIG. 2. The storage unit 5000 is an example of storage means.

The respective functional components of the management server 5 will be described.

The management server 5 may be implemented by a plurality of computers to which the functions of the management server 5 are distributed. Herein, the management server 5 is described as a server computer residing in a cloud environment. The management server 5 may also be a server residing in an on-premise environment.

The transmitting and receiving unit 51 is an example of transmitting means. The transmitting and receiving unit 51 is implemented by a command from the CPU 501 in FIG. 2 and the network I/F 509 to transmit and receive various data (or information) to and from another terminal, apparatus, or system via the communication network 100.

The processing unit 53 is implemented by a command from the CPU 501 in FIG. 2 to perform various processes including an alignment process and a superimposition process.

The determination unit 55 is implemented by a command from the CPU 501 in FIG. 2 to make various determinations.

The generation unit 57 is implemented by a command from the CPU 501 in FIG. 2 to perform various generation processes such as the generation of screens, which will be described later.

The storage and reading unit 59 is an example of storage control means. The storage and reading unit 59 is implemented by a command from the CPU 501 in FIG. 2, the HDD 505, the media I/F 507, the CD-RW drive 514, an external PC, and an external device. The storage and reading unit 59 performs processes such as storing various data in the storage unit 5000, the recording medium 506, the CD-RW 513, the external PC, or the external device and reading various data therefrom. The storage unit 5000, the recording medium 506, the CD-RW 513, the external PC, and the external device are examples of storage means.

The storage unit 5000 includes a user information management database (DB) 5001, a setting information management DB 5002, a storage process management DB 5003, a 3D data management DB 5004, and a processing result management DB 5005. Each of these databases is configured as a setting information management table.

In the user information management DB 5001, the file name of 3D data is stored and managed in association with user information. In the setting information management DB 5002, various setting information is stored and managed. In the storage process management DB 5003, various processing programs for executing information processing are stored and managed. In the 3D data management DB 5004, the 3D data is stored and managed. In the processing result management DB 5005, processing result information representing the result of executing the information processing on the 3D data is stored and managed.

The processing unit 53 includes a 3D superimposition processing unit 530 that performs a 3D superimposition process (a process of aligning a plurality of 3D data items and a screen creation process).

A functional configuration of the 3D superimposition processing unit 530 will be described.

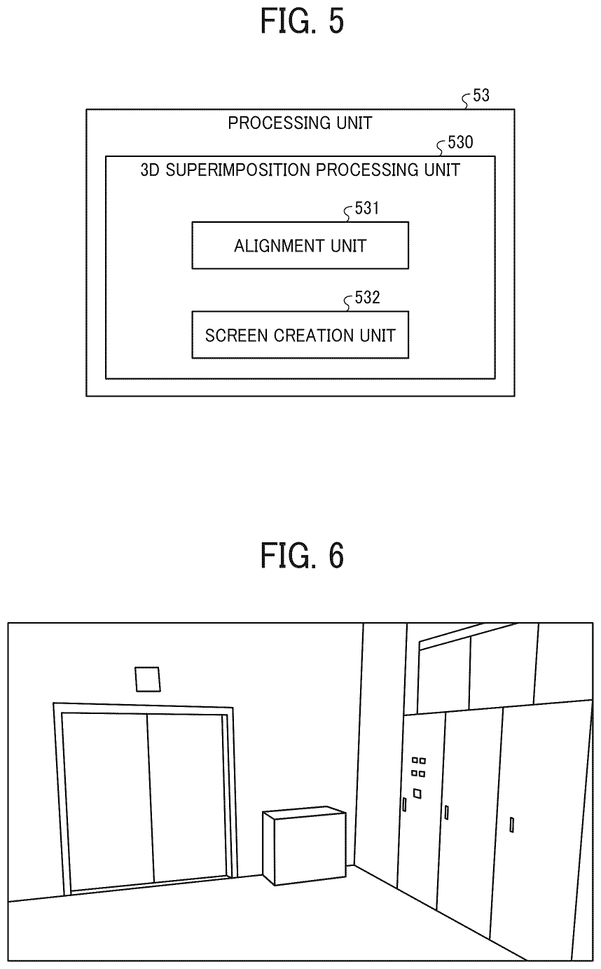

FIG. 5 is a functional block diagram illustrating an example of the 3D superimposition processing unit 530 according to the first embodiment. The 3D superimposition processing unit 530 includes an alignment unit 531 and a screen creation unit 532.

The alignment unit 531 aligns a plurality of 3D data items. A technique called registration is typically used to align a plurality of 3D data items. For example, there is a method of calculating corresponding points with the interactive closest point (ICP) algorithm or an algorithm with fast point feature histograms (FPFH) features and then finding rigid transformation for alignment with the random sample consensus (RANSAC) algorithm. These methods are mainly for three-dimensional point clouds, but may also be used for data reduced to two-dimension. In the first embodiment, these methods may be used to align 3D data items.

The screen creation unit 532 creates a screen that displays the plurality of 3D data items as aligned and superimposed on each other with the rigid transformation found by the alignment unit 531.

The plurality of 3D data items and superimposed display thereof will be described.

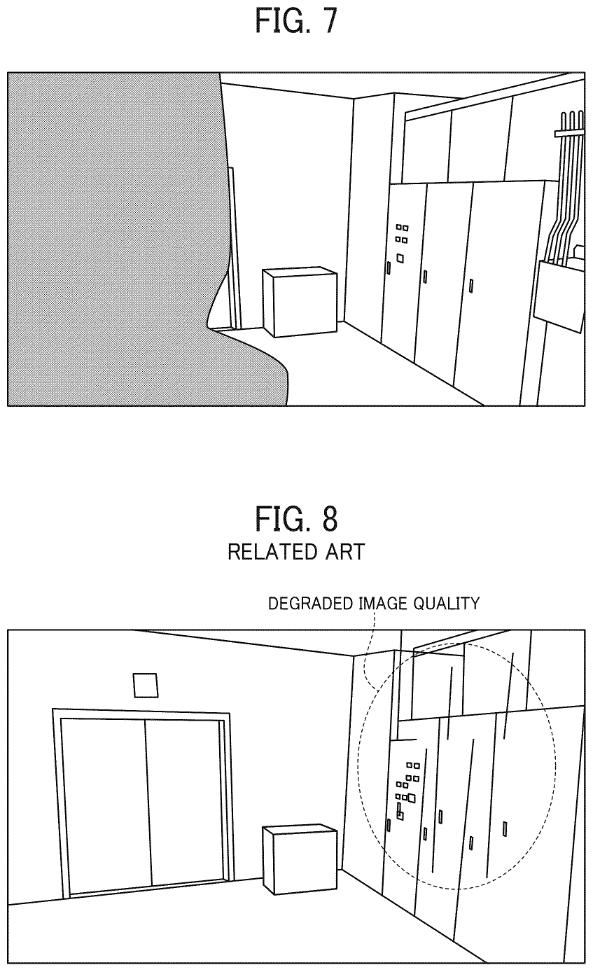

FIG. 6 is a diagram illustrating an example of 3D data obtained by photographing an entire room. FIG. 7 is a diagram illustrating an example of 3D data obtained by rephotographing a part of the room. In this example, the 3D data of the entire room is first obtained, as illustrated in FIG. 6. Then, the 3D data of a part of the room installed with equipment is obtained, as illustrated in FIG. 7. A black area on the left side of FIG. 7 is a data missing part of the data obtained by rephotographing.

The user may sequentially obtain the thus daily updated versions of the 3D data of the building and check the 3D data on the 3D viewer by switching between the plurality of 3D data items. The user may also check the 3D data on the 3D viewer by aligning and superimposing the plurality of 3D data items on each other. For example, if it is difficult to identify which part of the room has been updated with 3D data obtained by rephotographing the area of and around the updated part, the user may display the 3D data of the updated part as superimposed on the 3D data of the entire room.

FIG. 8 is a diagram illustrating an example of a superimposed screen created with a related-art technique. In the example of FIG. 8, the 3D data of FIG. 6 and the 3D data of FIG. 7 are superimposed on each other in the created screen. In this example, the image quality is degraded in an area encircled by a broken line.

The degraded image quality caused by the related-art technique may be due to a difference in accuracy between the two 3D data items photographed with different devices or inaccurate alignment of the two 3D data items, for example. In FIG. 8, inaccurate alignment in the area indicated by the broken line results in the deterioration in image quality; the photographed image of power supply equipment based on the two 3D data items looks double.

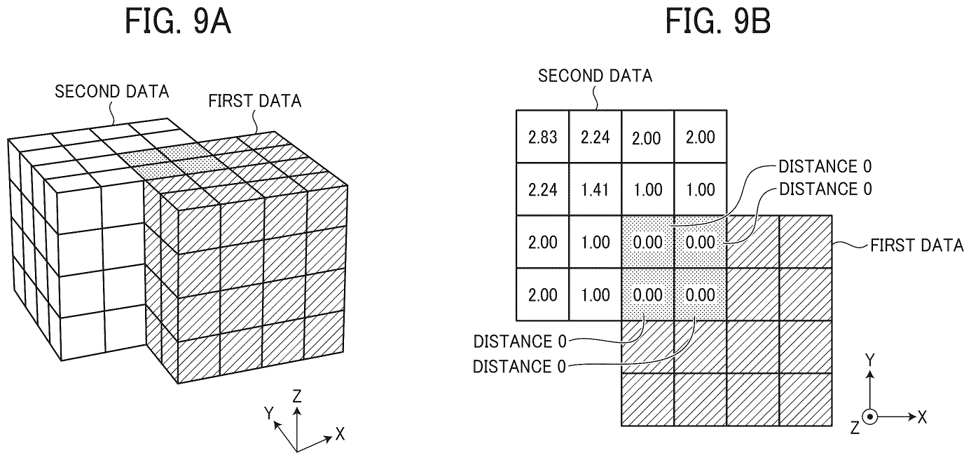

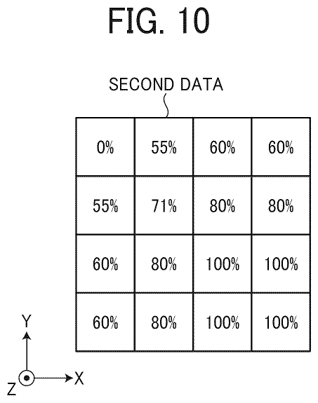

In the first embodiment, the screen creation unit 532 changes the display style of each of the component elements of the 3D data in accordance with the relative positions of the two 3D data items to improve the visibility. The display style of each of the component elements will be described with FIGS. 9A and 9B and FIG. 10.

FIGS. 9A and 9B are diagrams illustrating examples of a screen displaying two 3D data items superimposed on each other. In the following description, it is assumed that each of the two 3D data items includes 64 (=4×4×4) component elements (cubes). In FIGS. 9A and 9B, first data refers to most recently obtained 3D data, and second data refers to 3D data obtained before the first data.

FIG. 9A illustrates a screen displaying the superimposed first data and second data as viewed from diagonally above, and FIG. 9B illustrates a screen displaying the superimposed first data and second data as viewed from directly above. In FIG. 9B, a numerical value added to each of the component elements of the second data represents the distance from the first data when the length of each side of each cube is represented as 1. Herein, the distance between the component element of the second data and the first data is the distance between the component element of the second data and one of the component elements of the first data nearest to the component element of the second data (the nearest component element), i.e., the distance between the component elements. Further, the distance between the component elements is defined as the distance between the positions of the respective centroids of the component elements.

The distance between the component elements may be defined otherwise. For example, one of the vertices of each cube may be selected as a representative point, and the distance between the component elements may be defined as the distance between the respective representative points of the cubes.

The screen creation unit 532 determines the degree of transparency of each of the component elements of the second data in accordance with the distance calculated as described above. FIG. 10 is a diagram illustrating an example of the degrees of transparency of the component elements of the second data determined by the screen creation unit 532. In this example, when the distance of a component element in FIG. 9B is 0, the degree of transparency of the component element is set to 100%. Further, when the distance of a component element in FIG. 9B is equal to or greater than a particular threshold value T (e.g., 2.5), the degree of transparency of the component element is set to 0%. Herein, the threshold value T is a value previously set based on experiments, for example. As the threshold value T, the same value may be set for the 3D data items, or a different value may be set for each of the 3D data items, for example. Further, the threshold value T may be changed in accordance with the situation in which the 3D data is obtained.

When the distance (represented as d) is greater than 0 and less than the threshold value T, the degree of transparency (represented as A (%)) is calculated with the following equation (1), for example.

$$\begin{matrix}[ Math . 1 ] & \\ A = 100 - V 1 \times d & ( 1 )\end{matrix}$$

Herein, V1 is a constant representing the decrease rate of the degree of transparency. In FIG. 10, the decrease rate V1 is set to 20.

The screen creation unit 532 may change the degree of transparency with an equation using the increase rate (e.g., the increase rate according to the reciprocal of the distance) in place of the decrease rate. The decrease rate or the increase rate of the degree of transparency is an example of the rate of change of the degree of transparency.

As described above, in an area with a distance 0 (an area overlapping the first data), the screen creation unit 532 determines the degree of transparency of the second data to be 100%. Further, in an area with a distance greater than 0, the screen creation unit 532 determines the degree of transparency of the second data to be reduced with an increase in the distance. The screen creation unit 532 creates a screen that displays the second data in the above-described display style.

An area with a distance greater than 0 and less than the threshold value T is an example of a first area, and an area with a distance greater than the threshold value T is an example of a second area. Further, in an area including the second data alone, an area where the distance between the first data and the second data is less than the threshold value T is the first area, and an area other than the first area is the second area. An area where the distance is 0 is an example of a third area.

The screen creation unit 532 may display the second data in the first area in a first display style (with the degree of transparency according to the distance), display the second data in the second area in a second display style (with the degree of transparency set to 0%), and display the second data in the third area in a third display style (with the degree of transparency set to 100%).

The component elements of the 3D data may be other than the cubes. For example, the component elements may be points of a point cloud or faces of a mesh. If the component elements are points of a point cloud, the distance between the component elements may be the distance between the points. Further, if the component elements are faces of a mesh, the distance between the component elements may be the distance between the coordinates of the centers of the faces.

The number of the plurality of 3D data items may be three or more. In this case, the most recently obtained 3D data item of the plurality of 3D data items may be set as the first data, and the display style of each of the component elements of the second data, which is another 3D data item of the plurality of 3D data items, may be changed in accordance with the distance from the first data, for example. The first data may be a 3D data item of the plurality of 3D data items other than the most recently obtained 3D data item.

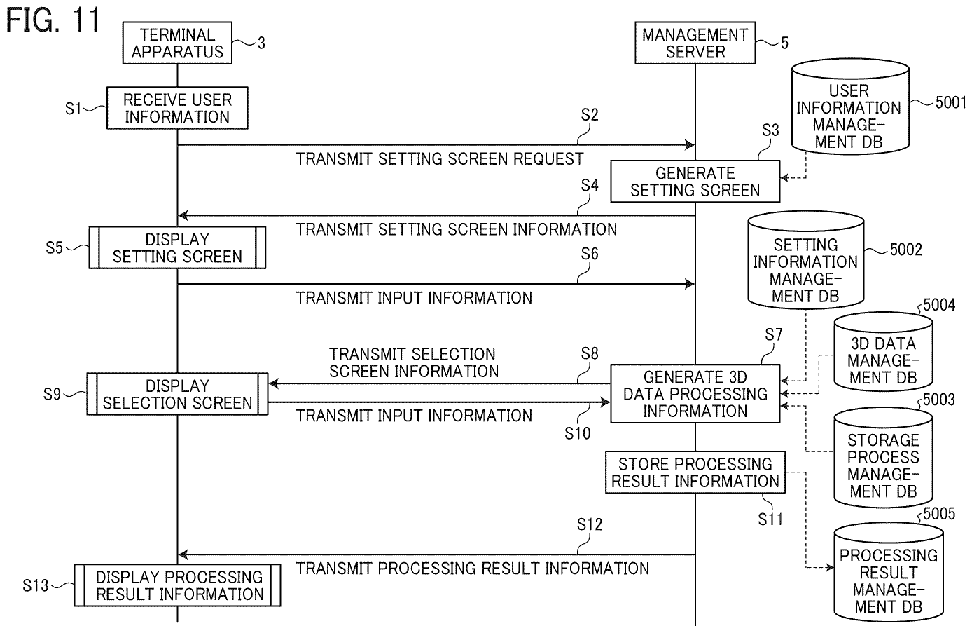

FIG. 11 is a sequence diagram illustrating an example of 3D data processing according to the first embodiment.

The receiving unit 32 of the terminal apparatus 3 receives an input operation related to the user information (step S1). The transmitting and receiving unit 31 of the terminal apparatus 3 transmits to the management server 5 a setting screen request including the user information received at step S1, and the transmitting and receiving unit 51 of the management server 5 receives the request transmitted from the terminal apparatus 3 (step S2).

Then, the storage and reading unit 59 of the management server 5 searches through the user information management DB 5001 by using the user information included in the request received at step S2 as a search key. Thereby, the storage and reading unit 59 reads the file name of 3D data associated with the user information included in the request. The generation unit 57 of the management server 5 generates a display screen including a setting screen based on the file name read by the storage and reading unit 59 (step S3).

The setting screen is a graphical user interface (GUI) screen in which the images of means for inputting 3D data information (e.g., the file name of the 3D data) and means for selecting the 3D data processing, for example, are arranged.

The transmitting and receiving unit 51 transmits to the terminal apparatus 3 display screen information including setting screen information related to the setting screen generated at step S3. The transmitting and receiving unit 31 of the terminal apparatus 3 receives the display screen information transmitted from the management server 5 (step S4).

The display control unit 34 of the terminal apparatus 3 causes the display 308 to display the display screen including the setting screen received at step S4 (step S5). The receiving unit 32 of the terminal apparatus 3 receives a particular input operation performed on the displayed setting screen by the user. The input operation includes an operation of inputting the 3D data information and the information of the 3D data processing. In the first embodiment, it is assumed that the user inputs information for instructing to execute the 3D superimposition process as the information of the 3D data processing.

The transmitting and receiving unit 31 transmits to the management server 5 input information related to the input operation received by the receiving unit 32. The transmitting and receiving unit 51 of the management server 5 receives the input information transmitted from the terminal apparatus 3 (step S6). The input information includes the 3D data information and the information of the 3D data processing input as described above.

The storage and reading unit 59 of the management server 5 searches through the 3D data management DB 5004 by using the 3D data information included in the input information received at step S6 as a search key. Thereby, the storage and reading unit 59 reads a plurality of 3D data items on which the 3D data processing is to be performed.

The storage and reading unit 59 further searches through the storage process management DB 5003 by using the information of the 3D data processing included in the input information received at step S6 as a search key. Thereby, the storage and reading unit 59 reads a 3D data processing program.

The processing unit 53 of the management server 5 generates 3D data processing information based on the 3D data read by the storage and reading unit 59, the settings stored in the setting information management DB 5002, and the 3D data processing program (step S7). The 3D data processing information is the information of the result of performing the 3D data processing on the 3D data.

The generation unit 57 of the management server 5 generates a display screen including a screen of the 3D data processing information (the result of the 3D data processing) and a selection screen for selecting whether to finish or re-execute the 3D data processing. The selection screen is a GUI screen in which the images of means for changing parameters of the 3D data processing, for example, are arranged. The transmitting and receiving unit 51 transmits the information of the generated display screen to the terminal apparatus 3 (step S8).

The transmitting and receiving unit 31 of the terminal apparatus 3 receives the information of the display screen transmitted from the management server 5, and the display control unit 34 of the terminal apparatus 3 causes the display 308 to display the received display screen. The receiving unit 32 of the terminal apparatus 3 receives a particular input operation performed on the displayed display screen by the user (step S9).

The input operation includes a selection operation to select whether to finish or re-execute the 3D data processing and an adjustment operation to adjust the processing result of the 3D data processing.

The transmitting and receiving unit 31 transmits to the management server 5 input information related to the input operation received by the receiving unit 32, and the transmitting and receiving unit 51 of the management server 5 receives the input information transmitted from the terminal apparatus 3 (step S10).

If the input information includes selection information indicating the selection to finish the 3D data processing, the processing unit 53 of the management server 5 determines the processing result of the 3D data processing.

If the input information includes selection information indicating the selection to re-execute the 3D data processing and adjustment information based on the adjustment operation, the processing unit 53 of the management server 5 re-executes the 3D data processing of step S7 based on the selection information and the adjustment information.

The processing unit 53 converts the processing result information into a file format readable with 3D data processing software, 3D-CAD software, or BIM/CIM software, for example. The storage and reading unit 59 stores the converted processing result information in the processing result management DB 5005, the recording medium 506, or the CD-RW 513 (step S11).

The transmitting and receiving unit 51 transmits the processing result information of the determined processing result to the terminal apparatus 3 (step S12).

The transmitting and receiving unit 31 of the terminal apparatus 3 receives the processing result information transmitted from the management server 5, and the display control unit 34 of the terminal apparatus 3 causes the display 308 to display the received processing result (step S13).

In the above-described processing, the functions of the management server 5 in FIG. 3 may be integrated into the terminal apparatus 3 such that the processes of the management server 5 in FIG. 11 are executed by the terminal apparatus 3.

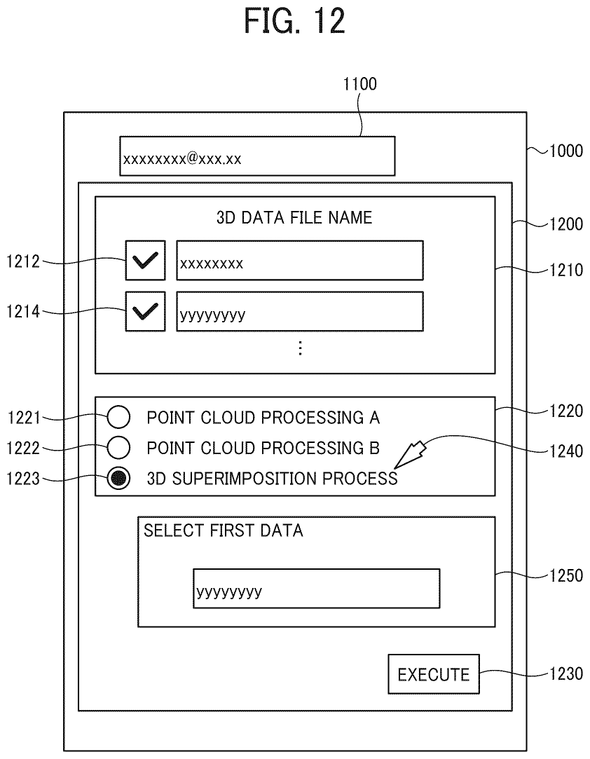

FIG. 12 is a diagram illustrating an example of a setting screen according to the first embodiment. FIG. 12 illustrates a display screen 1000 displayed on the display 308 of the terminal apparatus 3 at step S5 in the sequence diagram of FIG. 11.

The display control unit 34 of the terminal apparatus 3 causes the display 308 to display a user information display screen 1100 and a setting screen 1200 in the display screen 1000.

The setting screen 1200 includes a 3D data setting screen 1210, a process setting screen 1220, and an execute button 1230. The setting screen 1200 may further include a first data selection area 1250 to perform the 3D superimposition process of the first embodiment.

The 3D data setting screen 1210 is a screen for receiving an operation of setting the 3D data used to execute the 3D data processing. The display control unit 34 causes the display 308 to display 3D data setting areas 1212 and 1214 in association with the respective file names of a plurality of 3D data items read by the storage and reading unit 59. There may be three or more 3D data setting areas.

The process setting screen 1220 is a screen for receiving a setting operation of setting the type of 3D data processing. The display control unit 34 causes the display 308 to display process setting areas 1221, 1222, and 1223 in association with the respective names of plural types of 3D data processing. The display control unit 34 also causes the display 308 to display the execute button 1230 for confirming various setting operations.

The display control unit 34 further causes the display 308 to display a pointer 1240, which is operated with the mouse 312, for example, to select from the process setting areas 1221 to 1223.

To perform the 3D superimposition process of the first embodiment, the user operates the pointer 1240 to select “3D SUPERIMPOSITION PROCESS” in the process setting area 1223. In response to selection of “3D SUPERIMPOSITION PROCESS,” the display control unit 34 may cause the display 308 to display the first data selection area 1250 in the setting screen 1200. In this case, the user enters the file name of the first data in the first data selection area 1250 to select the first data. The display control unit 34 may also cause the display 308 to display, in the first data selection area 1250, radio buttons corresponding to the file names of the plurality of 3D data items to allow the user to select the first data by clicking one of the radio buttons. The first data selection area 1250 is an example of a setting unit that sets the first data.

If various setting areas are clicked with the pointer 1240, the display control unit 34 causes the display 308 to display a filled circle or checkmark in each of the setting areas, as illustrated in FIG. 12, and the receiving unit 32 of the terminal apparatus 3 receives various setting operations. If the execute button 1230 is operated, the various setting operations are performed, and the 3D data processing is executed.

Specifically, as described above in steps S6 and S7 of FIG. 11, the transmitting and receiving unit 31 of the terminal apparatus 3 transmits to the management server 5 the input information including various setting information based on the various setting operations received by the receiving unit 32. Then, the processing unit 53 of the management server 5 executes the 3D data processing.

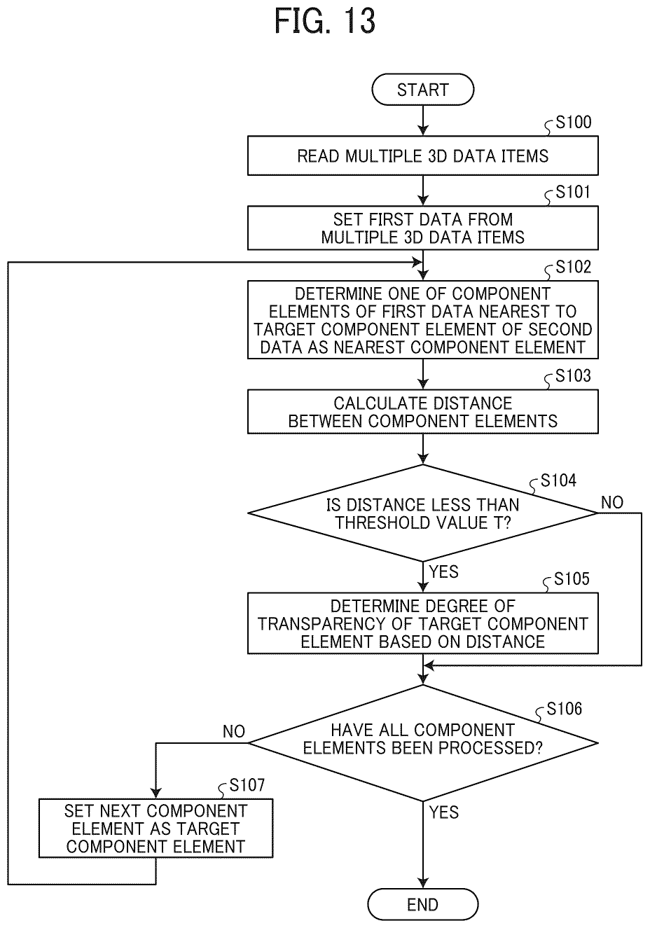

FIG. 13 is a flowchart illustrating an example of a procedure of the 3D superimposition process according to the first embodiment.

The storage and reading unit 59 first reads a plurality of 3D data items (step S100), and the processing unit 53 sets the first data from the read plurality of 3D data items (step S101). For example, the processing unit 53 sets a most recently obtained 3D data item of the plurality of 3D data items as the first data. If the first data selection area 1250 is displayed in the setting screen 1200, and if the first data has been selected by the user, the processing unit 53 may set the first data based on the selection by the user.

Then, the alignment unit 531 aligns the plurality of 3D data items, and the screen creation unit 532 creates a screen displaying the plurality of 3D data items superimposed on each other with the procedure of steps S102 to S107. In the procedure of steps S102 to S107, all component elements of the second data are scanned to determine the respective degrees of transparency of the component elements.

The screen creation unit 532 determines one of the component elements of the first data nearest to a target component element of the second data as the nearest component element (step S102). Herein, the target component element is a component element, the degree of transparency of which is to be determined. In the case of the second data in FIGS. 9A and 9B, the initial target component element is a component element at a position with the minimum XYZ coordinate values, for example.

The screen creation unit 532 then calculates the distance between the target component element and the nearest component element (step S103). If the calculated distance is less than the threshold value T (YES at step S104), the screen creation unit 532 determines the degree of transparency of the target component element in accordance with the distance (step S105). If the calculated distance is equal to or greater than the threshold value T (NO at step S104), the 3D superimposition process proceeds to step S106. It is assumed here that the initial value of the degree of transparency of the second data is 0%.

If all component elements have not been processed, i.e., if there is a component element yet to be set as the target component element (NO at step S106), the screen creation unit 532 sets the next component element as the target component element (step S107), and the 3D superimposition process returns to step S102. If all component elements have been processed (YES at step S106), the 3D superimposition process is completed.

In the case of the second data in FIGS. 9A and 9B, the next component element set at step S107 is a component element at a position with the X coordinate value incremented by 1, for example. If there is no component element at the position with the X coordinate value incremented by 1, the next component element is a component element at a position with the minimum X coordinate value and the Y coordinate value incremented by 1. If there is no component element at the position with the Y coordinate value incremented by 1, the next component element is a component element at a position with the minimum XY coordinate values and the Z coordinate value incremented by 1.

According to the first embodiment, the degree of transparency of each of the component elements of the second data is thus changed in accordance with the distance from the first data, to thereby improve the visibility when a plurality of three-dimensional data items are displayed as superimposed on each other.

A second embodiment of the present disclosure will be described.

In the first embodiment, the degree of transparency of each of the component elements of the second data is changed in accordance with the distance from the first data. In the second embodiment, in place of or in addition to the degree of transparency, the color of each of the component elements of the second data is changed to display the plurality of three-dimensional data items. The following description of the second embodiment will be given of differences from the first embodiment, with the description of the same components as those of the first embodiment being omitted.

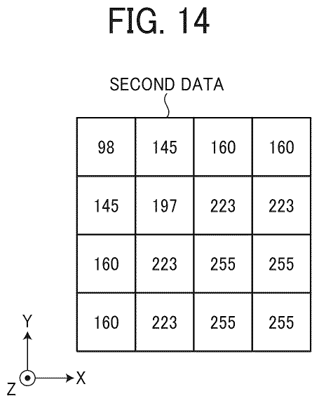

FIG. 14 is a diagram illustrating an example of color component values of the component elements of the second data determined by the screen creation unit 532. This example is different from the example of FIG. 10 in that the screen creation unit 532 determines the color component value (hereinafter occasionally simply referred to as the color component) in place of the degree of transparency. Changing the original values of the color components of the second data improves the visibility when the plurality of 3D data items are displayed as superimposed on each other.

In the example of FIG. 14, when the distance of a component element in FIG. 9B is 0, the color component of the component element is set to 255. Further, when the distance of a component element in FIG. 9B is equal to or greater than the threshold value T (e.g., 2.5), the color component of the component element is set to an original value of 98. It is assumed here that the color component is expressed by an 8-bit value ranging from 0 to 255. The color component may be any of the RGB components.

When the distance d is greater than 0 and less than the threshold value T, the value of the color component (represented as C) is calculated with the following equation (2), for example.

$$\begin{matrix}[ Math . 2 ] & \\ C = M - V 2 \times d & ( 2 )\end{matrix}$$

Herein, V2 is a constant representing the decrease rate of the color component. In FIG. 14, the decrease rate V2 is set to 63. Further, a constant M is set to 286 in FIG. 14. The screen creation unit 532 may change the color component with an equation using the increase rate (e.g., the increase rate according to the reciprocal of the distance) in place of the decrease rate. The decrease rate or the increase rate of the color component is an example of the rate of change of the color component.

The color component changed by the screen creation unit 532 may be one component of the RGB components or two or more components selected from the RGB components. Further, the screen creation unit 532 may change the color component alone, or may change both the degree of transparency and the color component. As the decrease rate V2 or the constant M, the same value may be set for the color components, or a different value may be set for each of the color components, for example.

According to the second embodiment, the color component value of each of the component elements of the second data is thus changed in accordance with the distance from the first data, to thereby improve the visibility when a plurality of three-dimensional data items are displayed as superimposed on each other.

A third embodiment of the present disclosure will be described.

According to the third embodiment, the parameters used in the 3D superimposition process are changeable on a selection screen. The following description of the third embodiment will be given of differences from the first and second embodiments, with the description of the same components as those of the first and second embodiments being omitted.

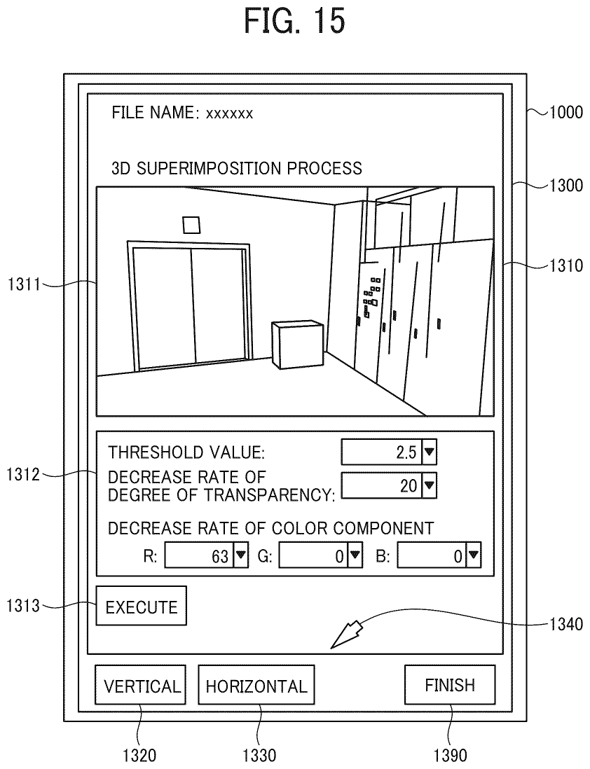

FIG. 15 is a diagram illustrating an example of a selection screen 1300 according to the third embodiment. FIG. 15 illustrates the display screen 1000 displayed on the display 308 of the terminal apparatus 3 at step S9 in the sequence diagram of FIG. 11. The display control unit 34 of the terminal apparatus 3 causes the display 308 to display the selection screen 1300 in the display screen 1000.

As illustrated in FIG. 15, the selection screen 1300 includes a processing result area 1310, a vertical button 1320, a horizontal button 1330, a pointer 1340, and a finish button 1390. The processing result area 1310 includes a processing result screen 1311 that displays the screen created through the 3D superimposition process, a parameter setting area 1312 for setting the parameters used in the 3D superimposition process, and an execute button 1313.

The parameter setting area 1312 includes pull-down menus (menus) for changing the threshold value T, the decrease rate V1 of the degree of transparency, and the decrease rate V2 of each of the color components. The user adjusts the values in the menus with the pointer 1340, which is operated with the mouse 312, for example.

The parameter setting area 1312 may not include all menus of parameters illustrated in FIG. 15. For example, it suffices if the parameter setting area 1312 includes a menu for at least one of the threshold value T, the decrease rate V1 of the degree of transparency, or the decrease rate V2 of each of the color components. The parameter setting area 1312 is an example of a setting unit that sets a threshold value. The parameter setting area 1312 is also an example of a setting unit that sets the rate of change of the degree of transparency that changes in accordance with the distance or the rate of change of the color component that changes in accordance with the distance.

Further, the parameter setting area 1312 may include a menu for a parameter other than the parameters illustrated in FIG. 15. For example, the parameter setting area 1312 may include a menu for the constant M in the above-described equation (2).

The means for changing the parameters may be other than the pull-down menus. For example, the parameter setting area 1312 may include boxes for entering numerical values in place of the pull-down menus.

The user clicks the vertical button 1320 or the horizontal button 1330 with the pointer 1340 to change the perspective vertically or horizontally to check the screen of the processing result from a desired perspective. If the user changes the parameters in the parameter setting area 1312 and clicks the execute button 1313, the processing unit 53 executes the 3D superimposition process with the changed parameters. Further, the generation unit 57 generates the display screen 1000 displaying the processing result screen 1311 created with the changed parameters.

The user checks the processing result on the processing result screen 1311. If necessary, the user changes the parameters again and executes the 3D superimposition process. The user clicks the finish button 1390 to finish the 3D superimposition process. The user may also click the finish button 1390 during the 3D superimposition process to suspend the process.

The operation for the user to check the processing result screen 1311 is not limited to the operation of changing the perspective, and may include an operation of zooming in or out a part of the processing result, for example. Further, operations such as changing the perspective may be performed through the operation of the mouse 312 (e.g., the rotation of a mouse wheel) instead of the vertical button 1320 and the horizontal button 1330.

Using the selection screen 1300 thus allows the user to repeatedly execute the 3D superimposition process by adjusting the parameters and readily check the result of the 3D superimposition process with the mouse 312, for example.

According to the third embodiment, the degree of transparency or the color component value of each of the component elements of the second data is thus changed in accordance with the distance from the first data, to thereby improve the visibility when a plurality of three-dimensional data items are displayed as superimposed on each other. Further, using the selection screen of the third embodiment enables executing the 3D superimposition process by changing the parameters used in the 3D superimposition process.

The above-described program executed on the information processing apparatus of the embodiments is provided as recorded on a computer-readable recording medium such as a compact disc-read only memory (CD-ROM), a flexible disk (FD), a CD-R, or a digital versatile disc (DVD) in a file of an installable or executable format.

Further, the program executed on the information processing apparatus of the embodiments may be stored in a computer connected to a network such as the Internet and be provided as downloaded via the network. The program executed on the information processing apparatus of the embodiments may also be provided or distributed via a network such as the Internet.

Further, the program of the embodiments may be provided as previously stored in a memory such as a ROM.

The program executed on the information processing apparatus of the embodiments is configured as a set of modules including the above-described units (e.g., the alignment unit 531 and the screen creation unit 532). As an actual hardware configuration, a CPU (processor) reads and executes the program from the above-described recording medium to load and generate the above-described units in a main storage device.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The apparatuses described in the embodiments are only illustrative of one of several computing environments for implementing the embodiments disclosed herein.

In some embodiments, the management server 5 includes a plurality of computing devices, e.g., a server cluster, that are configured to communicate with each other over any type of communications link, including a network, a shared memory, etc. to collectively perform the processes disclosed herein. Similarly, the terminal apparatus 3 can include a plurality of computing devices that are configured to communicate with each other.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The present disclosure relates to the following aspects, for example.

According to a first aspect, an information processing apparatus includes a screen creation unit that creates a screen that displays first data and second data as superimposed on each other. The first data is one of a plurality of three-dimensional data items obtained through measuring a target object at a plurality of different times. The second data is another one of the plurality of three-dimensional data items different from the first data. The screen creation unit displays the second data in a first area in a first display style. The first area is included in an area that includes the second data alone. In the first area, a distance between the first data and the second data is less than a threshold value. The screen creation unit displays the second data in a second area in a second display style different from the first display style. The second area is included in the area that includes the second data alone. The second area is different from the first area.

According to a second aspect, in the information processing apparatus of the first aspect, the screen creation unit creates the screen to display the second data in a third area in a third display style different from the first display style and the second display style. In the third area, the distance between the first data and the second data is zero.

According to a third aspect, in the information processing apparatus of the first or second aspect, the screen creation unit creates the screen to display the second data in the first area with a value according to the distance between the first data and the second data.

According to a fourth aspect, in the information processing apparatus of one of the first to third aspects, the screen creation unit creates the screen to display at least one of a degree of transparency or a color component of the second data in the first area with a value different from a value of the second data in the second area.

According to a fifth aspect, in the information processing apparatus of one of the first to third aspects, the screen creation unit creates the screen to display at least one of a plurality of color components of the second data in the first area with a value different from a value of the second data in the second area.

According to a sixth aspect, in the information processing apparatus of one of the first to fifth aspects, the distance between the first data and the second data is a distance between a component element of the second data and a component element of a plurality of component elements of the first data that is nearest to the component element of the second data.

According to a seventh aspect, the information processing apparatus of one of the first to sixth aspects further includes a setting unit that sets the first data from the plurality of three-dimensional data items.

According to an eighth aspect, in the information processing apparatus of one of the first to sixth aspects, the first data is a most recently obtained three-dimensional data item of the plurality of three-dimensional data items.

According to a ninth aspect, the information processing apparatus of one of the first to eighth aspects further includes a setting unit that sets the threshold value.

According to a tenth aspect, the information processing apparatus of the fourth aspect further includes a setting unit that sets a rate of change of the degree of transparency or the color component. The degree of transparency or the color component changes in accordance with the distance between the first data and the second data.

According to an eleventh aspect, the information processing apparatus of one of the first to tenth aspects further includes a display control unit that causes a display unit to display the screen.

According to a twelfth aspect, an information processing method is performed by an information processing apparatus that processes three-dimensional data. The information processing method includes creating a screen that displays first data and second data as superimposed on each other. The first data is one of a plurality of three-dimensional data items obtained through measuring a target object at a plurality of different times. The second data is another one of the plurality of three-dimensional data items different from the first data. The creating includes displaying the second data in a first area in a first display style. The first area is included in an area that includes the second data alone. In the first area, a distance between the first data and the second data is less than a threshold value. The creating further includes displaying the second data in a second area in a second display style different from the first display style. The second area is included in the area that includes the second data alone. The second area is different from the first area.

According to a thirteenth aspect, a non-transitory recording medium stores a plurality of instructions which, when executed by a computer, causes the computer to function as screen creation means to create a screen that displays first data and second data as superimposed on each other. The first data is one of a plurality of three-dimensional data items obtained through measuring a target object at a plurality of different times. The second data is another one of the plurality of three-dimensional data items different from the first data. The screen creation means displays the second data in a first area in a first display style. The first area is included in an area that includes the second data alone. In the first area, a distance between the first data and the second data is less than a threshold value. The screen creation means further displays the second data in a second area in a second display style different from the first display style. The second area is included in the area that includes the second data alone. The second area is different from the first area.

According to a fourteenth aspect, an information processing system includes an information processing apparatus and a terminal apparatus that is communicable with the information processing apparatus. The information processing system includes a screen creation unit and display control means. The screen creation unit creates a screen that displays first data and second data as superimposed on each other. The first data is one of a plurality of three-dimensional data items obtained through measuring a target object at a plurality of different times. The second data is another one of the plurality of three-dimensional data items different from the first data. The display control means causes a display unit to display the screen. The screen creation unit displays the second data in a first area in a first display style. The first area is included in an area that includes the second data alone. In the first area, a distance between the first data and the second data is less than a threshold value. The screen creation unit further displays the second data in a second area in a second display style different from the first display style. The second area is included in the area that includes the second data alone. The second area is different from the first area.

1. An information processing apparatus comprising circuitry configured to create a screen that displays first data and second data as superimposed on each other,
the first data being one of a plurality of three-dimensional data items obtained through measuring a target object at a plurality of different times, and
the second data being another one of the plurality of three-dimensional data items different from the first data,
the screen including, in an area including the second data alone,
a first area in which a distance between the first data and the second data is less than a threshold value, and
a second area different from the first area,
the first area displaying the second data in a first display style, and
the second area displaying the second data in a second display style different from the first display style.

2. The information processing apparatus of claim 1, wherein the screen further includes a third area in which the distance between the first data and the second data is zero, and
wherein the third area displays the second data in a third display style different from the first display style and the second display style.

3. The information processing apparatus of claim 1, wherein the circuitry creates the screen to display the second data in the first area with a value according to the distance between the first data and the second data.

4. The information processing apparatus of claim 1, wherein the circuitry creates the screen that displays at least one of a degree of transparency or a color component of the second data in the first area with a value different from a value of the second data in the second area.

5. The information processing apparatus of claim 1, wherein the circuitry creates the screen that displays at least one of a plurality of color components of the second data in the first area with a value different from a value of the second data in the second area.

6. The information processing apparatus of claim 1, wherein the distance between the first data and the second data is a distance between a component element of the second data and a component element of a plurality of component elements of the first data that is nearest to the component element of the second data.

7. The information processing apparatus of claim 1, wherein the circuitry sets the first data from the plurality of three-dimensional data items.

8. The information processing apparatus of claim 1, wherein the first data is a most recently obtained three-dimensional data item of the plurality of three-dimensional data items.

9. The information processing apparatus of claim 1, wherein the circuitry sets the threshold value.

10. The information processing apparatus of claim 4, wherein the circuitry sets a rate of change of the degree of transparency or the color component, the degree of transparency or the color component changing in accordance with the distance between the first data and the second data.

11. The information processing apparatus of claim 1, wherein the circuitry transmits screen data for display.

12. An information processing method comprising:
creating a screen that displays first data and second data as superimposed on each other, the first data being one of a plurality of three-dimensional data items obtained through measuring a target object at a plurality of different times, and the second data being another one of the plurality of three-dimensional data items different from the first data; and
displaying the screen on a display,
the screen including, in an area including the second data alone,
a first area in which a distance between the first data and the second data is less than a threshold value, and
a second area different from the first area,
the first area displaying the second data in a first display style, and
the second area displaying the second data in a second display style different from the first display style.

13. A non-transitory recording medium storing a plurality of instructions which, when executed by one or more processors, causes the one or more processors to perform an information processing method comprising:
creating a screen that displays first data and second data as superimposed on each other, the first data being one of a plurality of three-dimensional data items obtained through measuring a target object at a plurality of different times, and the second data being another one of the plurality of three-dimensional data items different from the first data; and
displaying the screen on a display,
the screen including, in an area including the second data alone,
a first area in which a distance between the first data and the second data is less than a threshold value, and
a second area different from the first area,
the first area displaying the second data in a first display style, and
the second area displaying the second data in a second display style different from the first display style.

14. An information processing system comprising:
circuitry configured to create a screen that displays first data and second data as superimposed on each other,
the first data being one of a plurality of three-dimensional data items obtained through measuring a target object at a plurality of different times,
the second data being another one of the plurality of three-dimensional data items different from the first data, and
display the screen on a display,
the screen including, in an area including the second data alone,
a first area in which a distance between the first data and the second data is less than a threshold value, and
a second area different from the first area,
the first area displaying the second data in a first display style, and
the second area displaying the second data in a second display style different from the first display style.
